(19) United States
(12) Patent Application Publication
(10) Pub. No.: US 2016/0300478 A1
(43) Pub. Date: Oct. 13, 2016

(54) MONITORING SYSTEM FOR AN AUTOMATED LUMINAIRE

(71) Applicants: Frantisek Kubis, Prostredni Becva (CZ); Martin Farnlk, Prostredni Becva (CZ)

(72) Inventors: Frantisek Kubis, Prostredni Becva (CZ); Martin Farnlk, Prostredni Becva (CZ)

(21) Appl. No.: 14/682,843

(22) Filed: Apr. 9, 2015

(51) Int. Cl. G08B 26/00

(52) U.S. Cl. CPC G08B 26/008; G08B 26/007; G08B 26/001; B65D 2211/00

(57) ABSTRACT

A monitoring system for automated luminaires for automated monitoring of the luminaire when not connected to mains power.

### RELATED APPLICATION(S)

Utility applications based on this provisional application may also claim priority as a continuation applications for utility applications filed claiming priority of provisional application 61/165,293 filed on 31 Mar. 2009 and utility application Ser. No. 12/749,681 filed on 30 Mar. 2010 and provisional application 62/144,123 filed on 7 Apr. 2015.

### TECHNICAL FIELD OF THE INVENTION

The present invention generally relates to an automated luminaire, specifically to the display and display control system within such a luminaire.

### BACKGROUND OF THE INVENTION

Luminaires with automated and remotely controllable functionality are well known in the entertainment and architectural lighting markets. Such products are commonly used in theatres, television studios, concerts, theme parks, night clubs and other venues. A typical product will typically provide control over the pan and tilt functions of the luminaire allowing the operator to control the direction the luminaire is pointing and thus the position of the light beam on the stage or in the studio. Typically this position control is done via control of the luminaire's position in two orthogonal rotational axes usually referred to as pan and tilt. Many products provide control over other parameters such as the intensity, color, focus, beam size, beam shape and beam pattern. The beam pattern is often provided by a stencil or slide called a gobo which may be a steel, aluminum or etched glass pattern. The products manufactured by Robe Show Lighting such as the ColorSpot 700E are typical of the art.

FIG. 1 illustrates a multiparameter automated luminaire system 10. These systems commonly include a plurality of multiparameter automated luminaires 103, 104, 105 which typically each contain on-board a light source (not shown), light modulation devices, electric motors coupled to mechanical drives systems and control electronics (not shown). In addition to being connected to mains power either directly or through a power distribution system (not shown), each luminaire is connected is series or in parallel to data link 102, 106, 107 to one or more control desks 101. The luminaire system is typically controlled by an operator through the control desk 101.

FIG. 2 illustrates the display 110 of a prior art automated luminaire. Such a display and display control will typically comprise a number of push buttons 112 and an alphanumeric display 114. By using the push buttons 112 to scroll through and select menu items on the display 114 the operator may view and edit operational parameters of the automated luminaire such as its DMX512 start address, fan speeds, movement speeds and other configuration information. In other examples of the prior art it is also possible to use such systems to interrogate and display parameters such as operating temperatures, the number of hours the unit has had in operation, lamp hours and so on. With increasing sophistication and complexity of the automated luminaire these menu display and control systems have become very large and difficult to navigate and utilize and are constrained by the fixed layout of the push buttons and alphanumeric display. It would be advantageous to have a display system that was reconfigurable and flexible so as to match the desired functionality.

A further limitation of the prior art is that only a restricted number of parameters, such as lamp hours and fixture hours, are stored in non-volatile memory so that the information is not lost when the unit is powered off and most other parameters are lost. Further there is no way to access or interrogate any product failures or events leading to those failures. Such diagnostics would be helpful for both servicing and tracking the lifetime use of the products.

There is a need for an improved display and display control system for an automated luminaire which provides simple and reconfigurable access to utilize and interrogate the operational parameters of the luminaire and that further tracks and permanently stores operational, service and event data for recall and investigation at any time.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a typical automated lighting system;

FIG. 2 illustrates a display control system of an automated luminaire;

FIG. 3 illustrates a view of display output;

FIG. 4 illustrates a further view of display output;

FIG. 5 illustrates a further view of display output;

FIG. 6 illustrates a further view of display output;

FIG. 7 illustrates a further view of display output

FIG. 8 illustrates a further view of display output;

FIG. 9 illustrates a view of a luminaire containing an embodiment of the monitoring system;

FIG. 10 illustrates structural blocks of and embodiment of the monitoring system;

FIG. 11 illustrates the process flow of the mains power detection and the polling engine of an embodiment of the monitoring system;

FIG. 12 illustrates a view of a road case of luminaires containing embodiment(s) of the monitoring system.

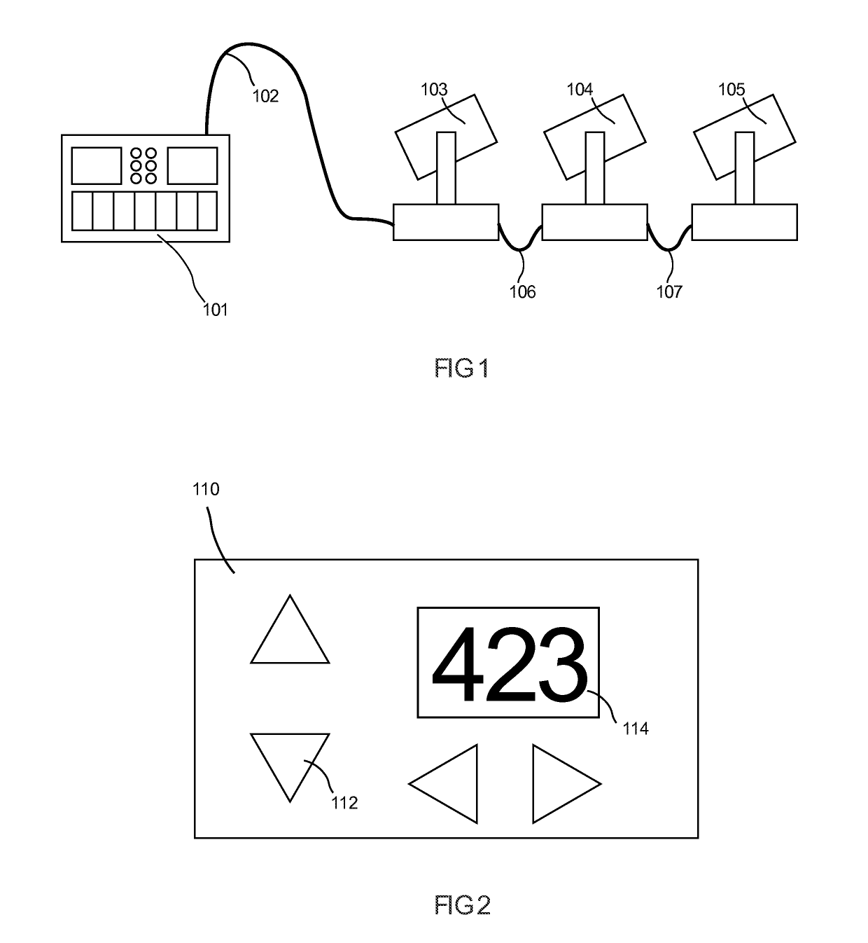

### DETAILED DESCRIPTION OF THE INVENTION

Preferred embodiments of the present invention are illustrated in the FIGUREs, like numerals being used to refer to like and corresponding parts of the various drawings.

The present invention generally relates to an automated luminaire, specifically to the display and display control system within such a luminaire and discloses means to provide simple and reconfigurable access to utilize and interrogate the operational parameters of the luminaire and that further tracks and permanently stores operational, service and event data for recall and investigation at any time.

FIG. 3 illustrates a display of an embodiment of the invention. Instead of utilizing physical push buttons and an alphanumeric display as in the prior art display 201 is a high resolution graphic display capable of showing any desired graphics or characters. Further the display is fitted with a touch panel so that no external push buttons are required. In operation any area or feature of the display 202 may be configured to behave as a touch sensitive area to select or interrogate features. This type of display is inherently reconfigurable, reprogrammable and flexible to accommodate any future enhancements desired by the luminaire manufacturer. In FIG. 3 eight areas 202 of the screen 201 have been configured to act as selectable touch buttons to select one of eight features or sub-menus. The touch panel may be a resistive touch panel, a capacitive touch panel or other touch panel technology as well known in the art.

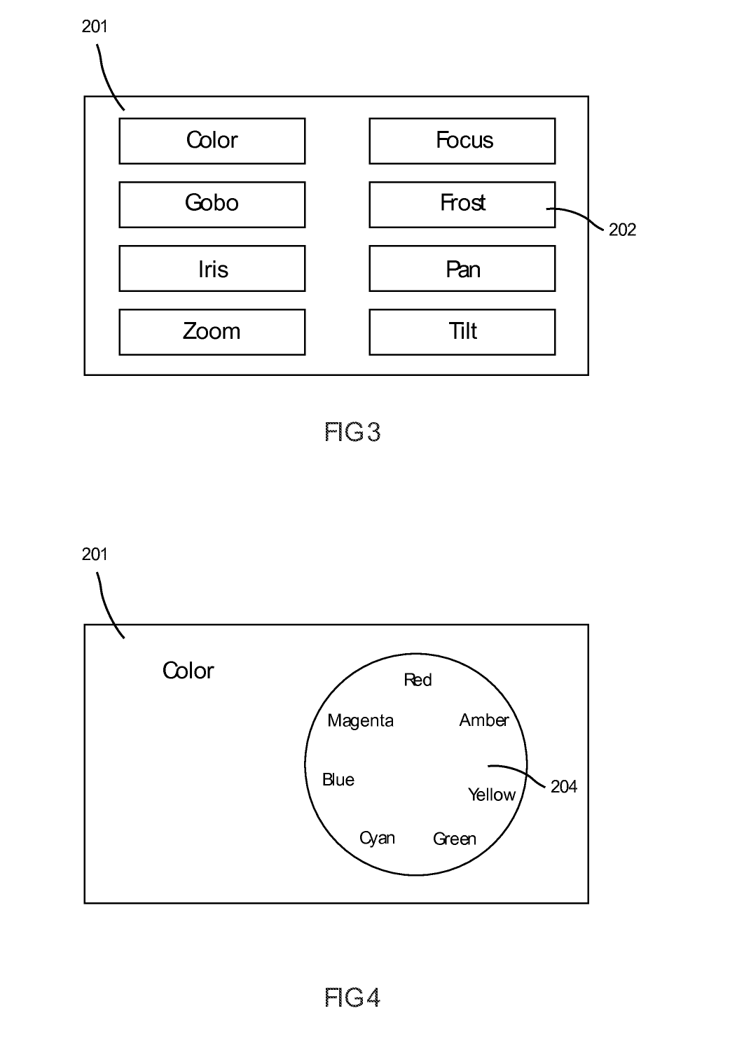

FIG. 4 illustrates a further display of an embodiment of the invention. In this figure the display 201 is showing a color map 204 which contains a representation of all the possible colors that the luminaire is capable of producing in a graphic layout. Note that this may be just a colored graphic as opposed to the text labels illustrated here. By touching the color map at the desired point the luminaire may change to the selected color. This operation is much simpler and more intuitive than the prior art method of controlling the individual color parameters such as Red, Green, Blue levels or Cyan, Magenta, Yellow levels independently using up/down push buttons.

FIG. 5 illustrates a further display of an embodiment of the invention. In this figure the display 201 is showing all the patterns or gobos that are mounted on one of the gobo wheels 208 of the luminaire. One of the gobos 210 may be selected by touching its image and an enlarged image of the gobo 206 may then be displayed. The luminaire may also change to the selected gobo. The wheel may be rotated by touching and dragging the graphic gobo wheel 208. The physical gobos used in the luminaire may be interchangeable and an aspect of the invention is the ability to upload new graphic images to the luminaire such that the images displayed on the displayed wheel 208 match those on the physical gobo wheel. Such data may be transferred to the luminaire by means selected from a list including but not limited to a DMX512 interface, an ethernet interface, a RDM interface, a USB interface, an Infra red interface an RS485 interface, an RS232 interface, a Wi-Fi interface, a Zigbee interface, an RFID interface, and other data transmission means well known in the art.

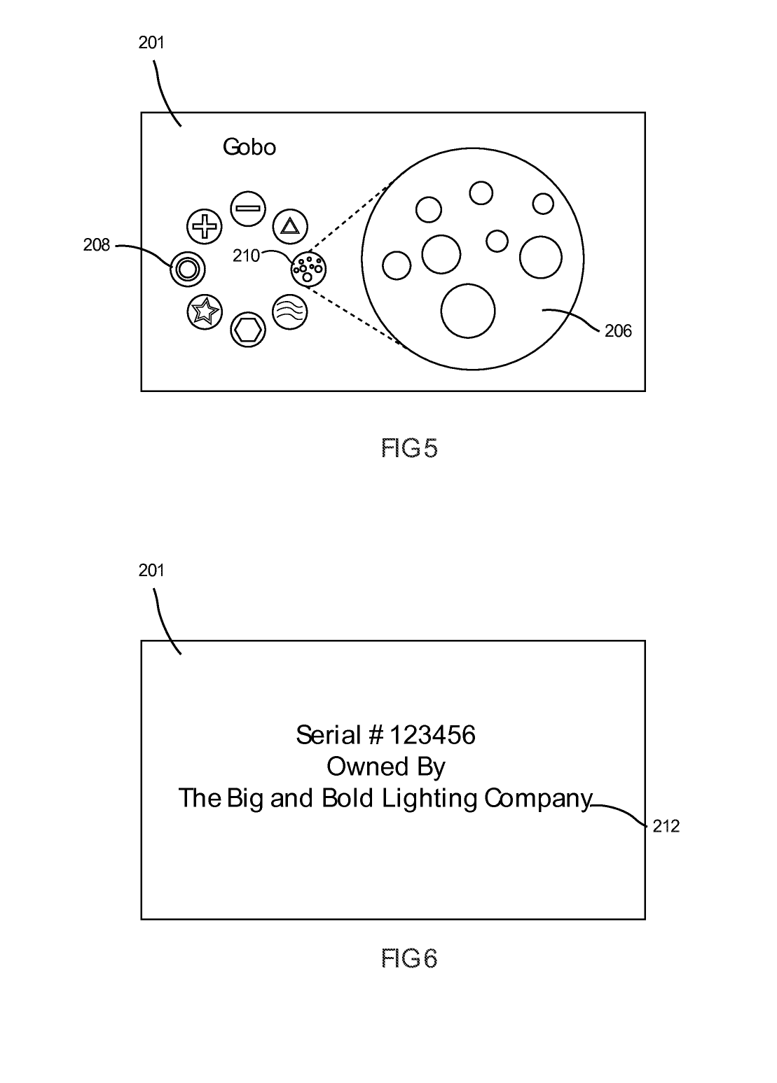

FIG. 6 illustrates a further display of an embodiment of the invention. In this figure the display 201 is showing information as to the serial number and owner 212 of the luminaire. This is particularly useful to a rental company as a means to establish identity and ownership of the luminaire. An aspect of the invention is the means to enter this information in a secure means utilizing a password so that it cannot be altered by a user. The display may include a graphic image of the logotype or other relevant graphic image of the owner.

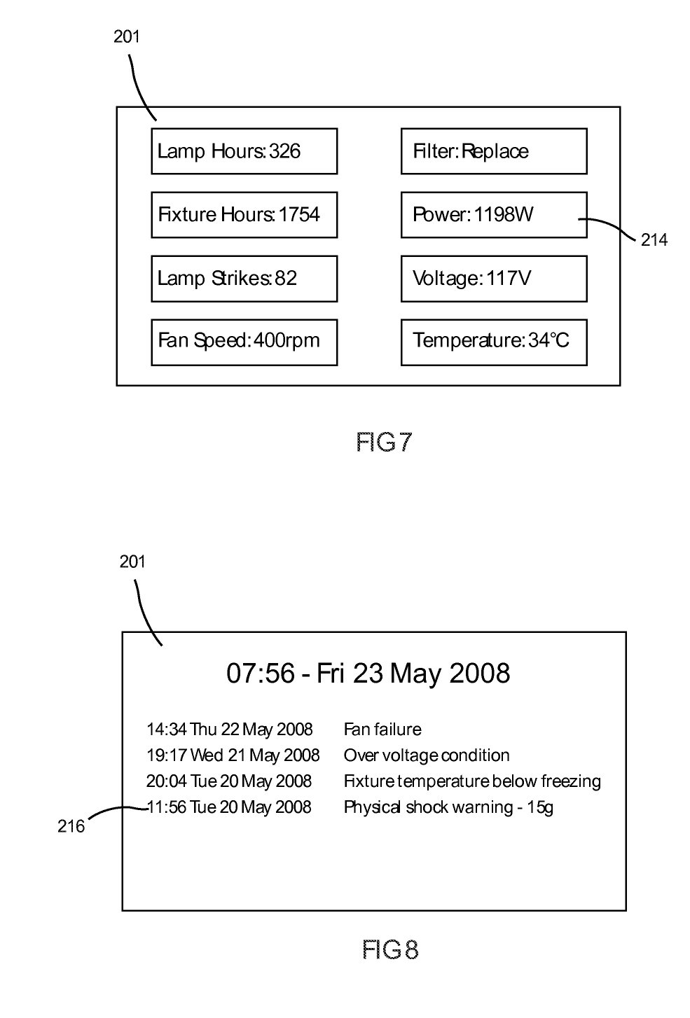

FIG. 7 illustrates a further display of an embodiment of the invention. In this figure the display 201 is showing live information relating to operational parameters of the luminaire. Information displayed 214 may relate to a list including but not restricted to: Lamp hours, fixture hours, lamp strikes, fan speeds, luminaire power consumption, luminaire voltage, luminaire current, luminaire power factor, ambient temperature, electronics temperature, lamp temperature, motor temperature, optical enclosure temperature, power supply temperature, air filter condition, air pressure, humidity, motor speeds, DMX512 values, acceleration for physical shock measurement, failure warnings and other parameters well known in the art.

FIG. 8 illustrates a further display of an embodiment of the invention. In this figure the display 201 is showing logged information 216 relating to operational events, diagnostics, failures and other data relevant to the usage, service and maintenance of such a luminaire. These events may be permanently stored in non-volatile memory such that they can be interrogated and retrieved at any time in the future. The display system may contain a real time clock such that these events may be logged with a date and time stamp showing when the event occurred.

The operational and diagnostic logging data illustrated in FIG. 8 may be collected and stored in the luminaire for later interrogation by the user, service facility or owner. This data may be viewed interactively on the screen and/or uploaded to an external diagnostic computer. The data may be transferred to the diagnostic computer by means selected from a list including but not limited to a DMX512 interface, an ethernet interface, a RDM interface, a USB interface, an Infra red interface an RS485 interface, an RS232 interface, a Wi-Fi interface, a Zigbee interface, an RFID interface, and other data transmission means well known in the art.

In a further embodiment the luminaire may be connected directly to the internet and a remote facility or service center may access the luminaire for retrieval of the operational and diagnostic data. Such access may be protected via password protection or other security means.

In a further embodiment the display system is fitted with a battery or other power source such that diagnostic data can be accumulated when the luminaire is disconnected from the mains power supply. For example the luminaire may accumulate data relating to acceleration of the luminaire from internal accelerometers as a warning of physical shock imparted during shipping or transportation. In another example the luminaire may log that it has been stored at low temperatures and the lamp and lubricants may require time to warm up before operating. The battery system may also allow setting of operational parameters such as the DMX512 address as the luminaire is being installed but before power is connected and available.

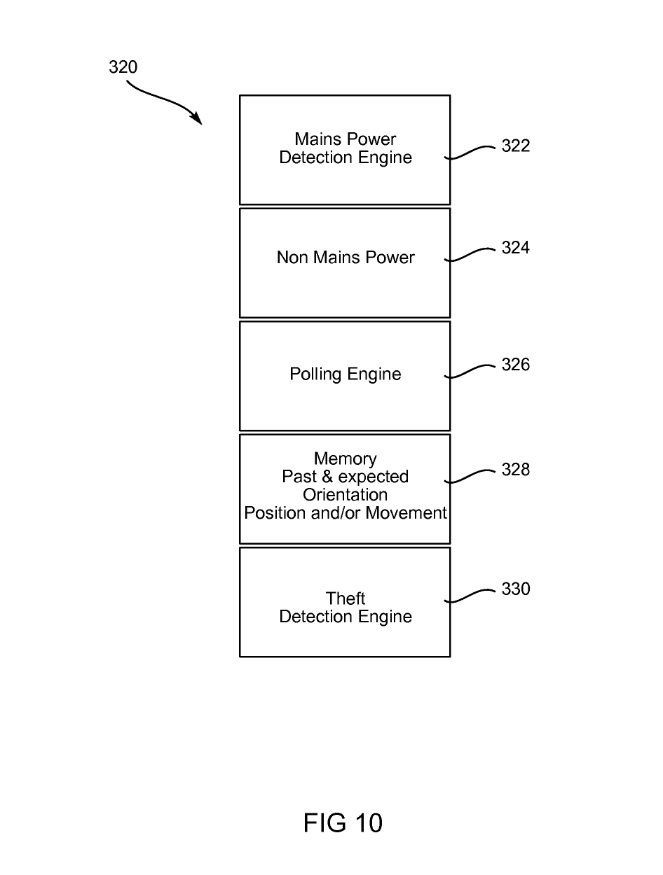

FIG. 10 illustrates diagram of architectural blocks of electronic hardware, software or firmware for an embodiment of a luminaire monitoring system when the luminaire is not connected to mains power. Some of the blocks by necessity need to be hardware such as a non-mains power source 324—which typically would be a battery of various types that are known and available in the art. Others may be manifest in a hardware circuit, or firmware in a hardware circuit or in software run on a processor—for example the mains power detection engine 322. In any case in at least one embodiment, the architectural blocks include the following: A mains power detection engine 322 which detects whether the luminaire is connected to mains power. A non-mains power source 324 such as a battery or other portable power supply that powers the luminaire monitoring system with which diagnostic data can be accumulated when the luminaire is disconnected from the mains power supply. A polling engine is employed, txan off mains power monitoring system can operate without recharging or replacing the power source.

After mains power is removed the display system enters ‘Polling Mode’ where the system is normally in a minimal power consumption or sleep condition. A timer operates and will wake the system on a regular repeating time interval. The duration of this repeating time interval may be set by the user or be a pre-programmed setting. For example the repeating time interval may be five minutes. On waking the system will accumulate data from attached sensors and store this data in non-volatile storage. The system may also interrogate an accelerometer within the luminaire that is capable of providing three-dimensional data as to the direction relative to the luminaire axes of the force of gravity. The system will compare this direction to that stored from the prior reading taken at the previous wake time and will amend its behavior accordingly.

If the direction of the force of gravity hasn't changed from the prior measurement then the system assumes that the luminaire has not been moved and will go back into the minimal power ‘sleep’ condition or ‘Polling Mode’ awaiting the next wake signal from the timer.

If, however, the direction of the force of gravity has changed from the prior measurement, such as when a luminaire is removed from its installed position in an installation and placed in a road case, then the system will recognize this change and will enter a ‘Full Monitoring Mode’ for an extended time. The duration of this extended time interval may be set by the user or be a pre-programmed setting. For example the repeating time interval may be two hours. During this extended time the system will continuously accumulate data relating to acceleration of the luminaire from internal accelerometers as a warning of physical shock imparted during shipping or transportation. It may also log temperatures and other parameters. After the extended time interval has expired the system may make a further decision based on current acceleration, temperature and other sensor readings whether to continue in ‘Full Monitoring Mode’ or to return to “Polled Mode’.

It can be seen that such a system with the ability to dynamically switch between the low power ‘Sleep Mode’ and the higher power ‘Full Monitoring Mode’ dependant on external conditions and the response of sensors provides an improved system to monitor potentially damaging parameters applied to the luminaire while also ensuring the maximum life from the power source.

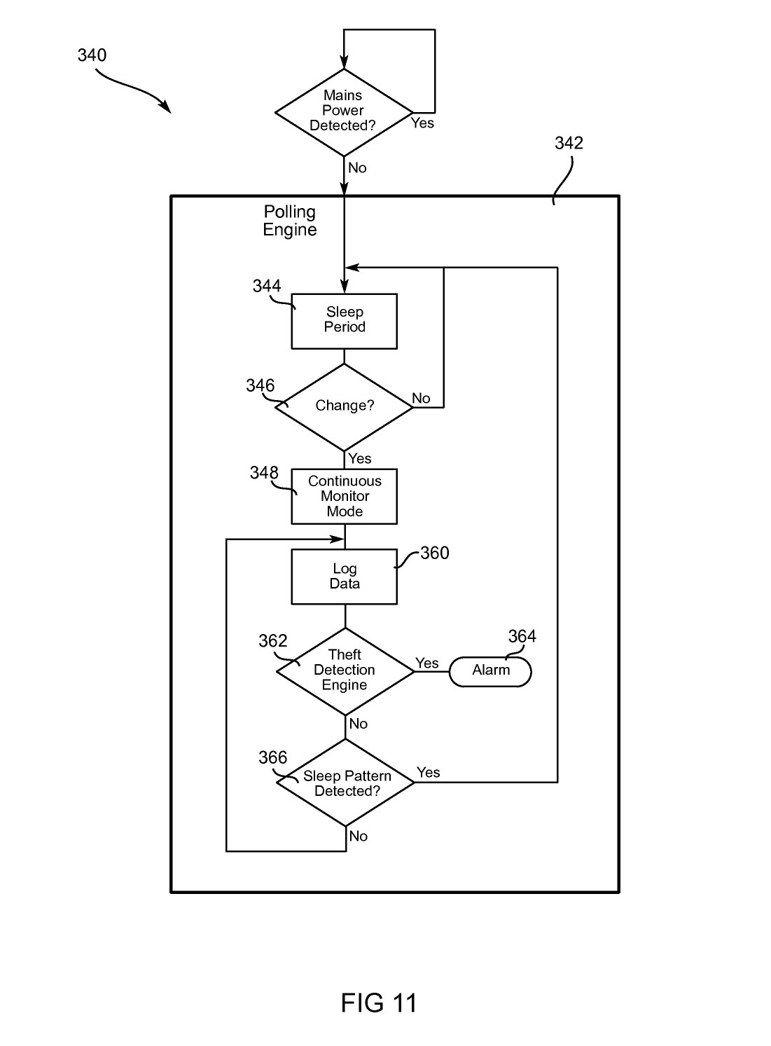

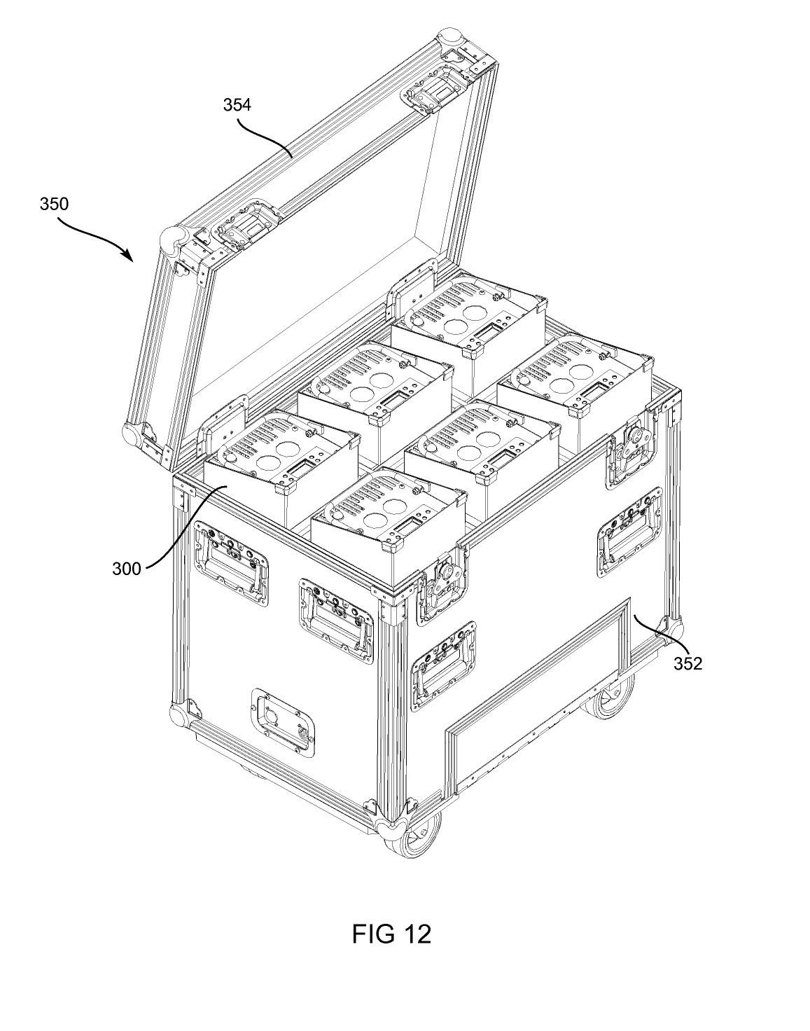

FIG. 11 illustrates process flow 340 of an embodiment employing a polling engine 342. The system monitors if the luminaire is connected to mains power. If mains power is not detected the polling engine 342 is implemented. Though not so shown in FIG. 11, if at any time mains power is detected the polling engine 342 is disengaged as long as the mains power connection is maintained. In an actual embodiment If an anytime mains power is detected. The polling engine initially puts the monitoring system into a periodic sleep mode 344. In this mode the monitoring system periodically wakes up to poll the sensors for change in orientation, position and/or motion 346. If there is no change it remains in the periodic sleep mode. However, if there is a change it enters into a continuous monitor mode 348 which gathers information from the sensors with much higher frequency for current information and logs the data 360. While collecting the information the polling engine includes a sleep pattern detection engine 366 which looks for sleep patterns which indicate that the system should be put back into sleep mode decreasing power consumption.

The display system may be fitted with a single physical push button to allow activation of the display when it is operating on battery power.

The luminaire may be installed in multiple orientations and consequently the display may be upside down or in any other orientation. In a further embodiment of the invention the display will reorient the displayed image so as to always provide a correctly oriented result. This reorientation may be automatic through the input from accelerometers or tilt switches or may be controlled by the user though controls on the display itself

The display may be fitted with a protective cover that may be transparent to protect the display in use and shipping.

The embodiment illustrated in FIG. 11 also includes a theft detection engine 362. The theft detection engine 362 looks at the information gathered from the sensors and compares it to sensor information that is expected and determines if patterns of actual changes in the sensors indicate that the luminaires have been stolen. If such a pattern is detected an alarm is triggered

In some embodiments, the luminaire monitoring system uses the accelerometers within the luminaire to collect information for an anti-theft or anti-tamper monitoring system. For example, a luminaire fitted with the accelerometer system may regularly poll the accelerometer for changes in orientation/position or movement. Such changes may indicate that the luminaire is being picked up or stolen. In sum embodiments gathered information can be compared to expected changes to look for patterns indicating theft. The pattern may be as simple as an assumption the luminaires should not be moved so any sustained movement is an indication of theft.

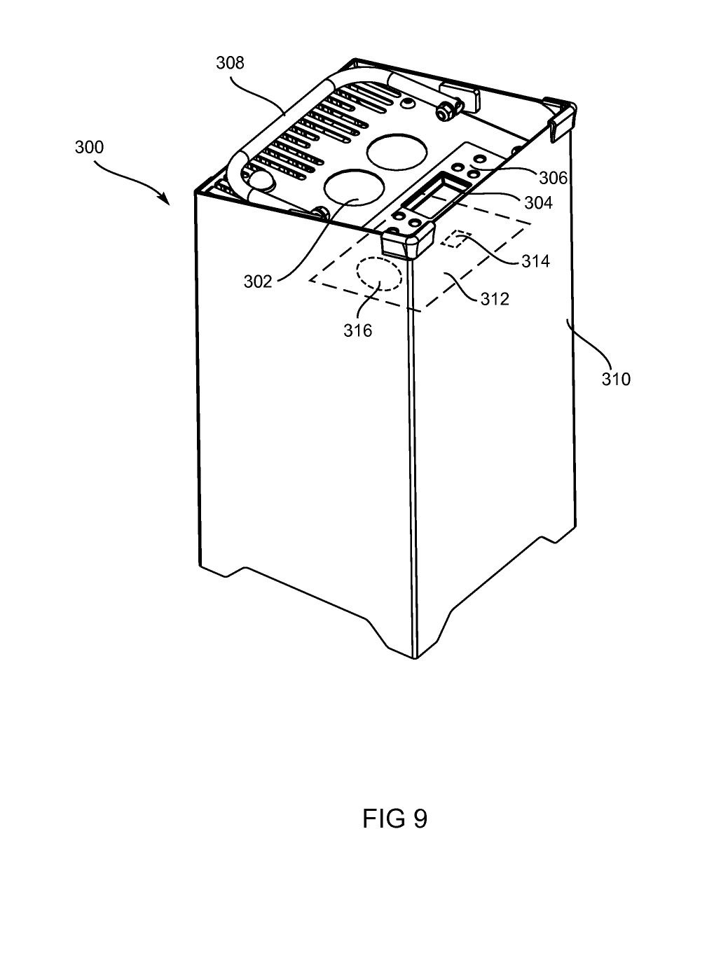

FIG. 9 illustrates an embodiment of the invention utilized as an anti-theft or anti-tamper device within a luminaire. Luminaire 300 is a portable luminaire that, in the embodiment illustrated is battery powered for both illumination and monitoring functions, however the invention is not so limited. In a situation where the luminaire is mains powered, then the alarm and monitoring system may be separately battery powered. Luminaire body 310 contains light sources 302, display 304, controls 306 and carrying handle 308. Within luminaire 300 may be circuit board 312 fitted with accelerometer 314. After the operator has positioned luminaire 300 and adjusted it such that the light emitters 302 are illuminating the desired object, the ant-theft system may be activated. In this mode the systems within luminaire 300 will continuously monitor and/or regularly poll the accelerometer 314 mounted on circuit board 312 looking for accelerations indicating movement of the luminaire. The system may be adjusted so as to ignore small amplitude accelerations, or accelerations continuing for a short period of time. This leeway allows the operator to make small adjustments in the positioning of the luminaire without triggering the alarm. However, if the magnitude and duration of detected accelerations exceed preset limits indicating a large or continued movement of the luminaire then the alarm will be triggered. When the alarm is triggered this may in turn trigger an audible alarm 316 comprising an internal siren, loudspeaker, whistle or other noise making device, a visible alarm through flashing the light sources 302, or a silent alarm by signaling back to the control console.

Once the alarm system has triggered, the unit will continue to sound the alarm until the system is reset. The operator may reset the system through a code combination in the menu display system 304 or through a secure command through the control system using a means selected from a list including but not limited to a DMX512 interface, an ethernet interface, a RDM interface, a USB interface, an Infra red interface an RS485 interface, an RS232 interface, a Wi-Fi interface, a Zigbee interface, an RFID interface, and other data transmission means well known in the art. The controls to disable the alarm may be through a touch screen as previously described, or through conventional buttons or other means of entering a code or combination of buttons.

Such a system may utilize the battery saving polling systems previously described so that the anti-theft function remains active even when the luminaire is turned off and not producing light. The preset limits for duration and magnitude of the accelerations required to trigger the alarm may be adjusted by the operator. For example, the duration of the acceleration required to trigger an alarm may be adjustable from 1 to 10 seconds.

FIG. 11 illustrates a system 352 comprising a plurality of luminaires 300 contained in a road case 352. The road case 352 may be fitted with a lid 354 and be used for transportation of the luminaires 300. Road case 352 may also be used to charge the batteries in luminaires 300 through integral male and female connectors that mate when the luminaires 300 are inserted into the road case 352. The anti-theft monitoring system described above may then be activated on one or more of the luminaires 300 within the road case 352 and will be able to detect movement of the road case, perhaps indicating a theft attempt, and sound an alarm as previously described.

In some embodiments the alarm may be audible, in other embodiments it may be visual on the display or otherwise visual. For example when the luminaire is plugged into mains power it exhibits behavior that indicates that its use is unauthorized—such as strobing. In some embodiments the alarm may be transmitted over a network when the fixture is connected hardwire or wirelessly on a network. In some embodiments, the alarm may be silently transmitted to a home location and may include whatever location information is available to the luminaire at the time of transmittal

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

We claim:

1. An automated luminaire monitoring system comprising:
sensors which generates information concerning changes in orientation, position or movement;
power source which powers the monitoring system when the luminaire is not connected to mains power;
a polling engine which puts the monitoring system in a sleep mode from which it periodically wakes to pole information from the sensors to detect changes in the orientation position or movement of the luminaire.

2. The automated luminaire monitoring system of claim 1 wherein the if changes are detected from the information gathered from the sensors, the monitoring system increases the frequency of polling the sensors for information

3. The automated luminaire monitoring system of claim 2 where the monitoring frequency is functionally continuous

4. The automated luminaire monitoring system of claim 1 which includes a theft prediction system which triggers an alarm when theft is predicted.

5. The automated luminaire monitoring system of claim 4 where the alarm is audible

6. The automated luminaire monitoring system of claim 4 where the alarm is visual.

7. The automated luminaire monitoring system of claim 4 where the alarm is silently transmitted over a network to a remote site or service station.

8. The display control system of claim 3 where the luminaire enclosed in a road case and the transfer does not require opening the road case.

9. The display control system of claim 5 where the transfer is wireless.

10. The automated luminaire monitoring system of claim 1 which incorporates a real time clock and events can be logged with a date and time stamp.

11. The automated luminaire monitoring system of claim 1 also stores information which may include non-event information such as: serial number, owner identification, or battery status.
